(19) United States
(12) Patent Application Publication
(10) Pub. No.: US 2021/0212305 A1
(43) Pub. Date: Jul. 15, 2021

(54) Insect Trap with Multi-textured Surface

(71) Applicants: Deborah Woods, Cary, NC (US); Liza Coronado, Clayton, NC (US)

(72) Inventors: Deborah Woods, Cary, NC (US); Liza Coronado, Clayton, NC (US)

(21) Appl. No.: 16/739,664

(22) Filed: Jan. 10, 2020

(51) Int. Cl. A01M 1/02; A01M 1/10; A01M 1/04

(52) U.S. Cl. CPC A01M 1/026; A01M 2200/011; A01M 1/04; A01M 1/103

(57) ABSTRACT

An insect trap includes an interior chamber portion, comprising side walls and a floor, each side wall having an interior bottom region adjacent to the floor and an interior top region adjacent to the interior bottom region and apart from the floor. The interior bottom region of each wall has a surface finish substantially smoother than a surface finish of the interior top region of the wall. Accordingly, while a target type of insect can traverse the interior top region of each wall when the wall is in a vertical orientation, due to the relatively rough surface finish of this interior top region, an insect attempting to traverse the interior bottom region of the wall will slip and fall onto the floor and be unable to climb back up the wall, due to the smoother surface finish.

### TECHNICAL FIELD

The present disclosure generally relates to pest control, and more particularly relates to the detection of bedbug infestations.

### BACKGROUND

Indoor insects are considered pests because they can be nuisances and a source or symptom of health risks. Detecting pests is the first step to know a problem exists. Classifying them is essential to prescribe and implement an appropriate treatment. Doing both quickly can prevent infestations.

Personally encountering pests is one way to both detect and classify. People may readily see or feel ants, flies, gnats and mosquitoes because these insects make little effort to conceal their presence. People may also see cockroaches, fleas and bedbugs, but more effort or chance is required because they are nocturnal, very small and/or hide out-of-sight. Of course, people generally prefer to not encounter pests at all, especially in their living spaces.

Traps rarely eradicate pests, but can reduce encounters between pests and humans. Conventional traps tend to require significant human effort to inspect, detect and classify incarcerated insects or remains thereof. Traps also do not provide any indication when pests enter them; significant time may elapse between inspections, allowing infestations to propagate. Conventional traps can also be obtrusive and dangerous. For example, they may occupy significant space in plain sight, produce odors, release toxins, and ensnare children or pets. Conventional traps can also be expensive. Many traps on the market cost several tens of dollars and still require human labor to frequently inspect them. Some traps require chemicals and dyes to lure and/or illuminate trace indications of pests; this compounds the associated labor requirements.

Bedbugs are of particular concern to homeowners as well as hospitality and transportation industries. Considered more of a nuisance than a health hazard, bedbugs lurk in dark crevices of living spaces. Bedbugs are small, flat, wingless insects with six legs that, like mosquitoes, fleas, mites and biting gnats, feed exclusively on blood from animals and humans. They range in color from nearly white to brown, and they turn rust-red after feeding. The common bedbug is usually less than 0.2 inches (5 mm) in length, making it easy to miss with the naked eye. Bedbugs are so named because they mostly hide in bedding and mattresses.

Bedbugs are commonly found in hotels, hostels, shelters, apartment complexes, cruise ships, buses, airplanes, trains, and waiting rooms, all of which are places where multiple people may pass through and/or stay for brief periods of time. Bedbugs are nocturnal and can hide in beds, floors, furniture, wood and paper trash during the day. Because bedbugs hide in small crevices, they can stow away in or on luggage, pets, furniture, clothing, boxes and other objects. Bedbugs may relocate from their original luggage homes to adjacent luggage in cargo holds, causing further spread. Bedbugs are found worldwide, but are most common in developing countries. Unsurprisingly, bedbugs are most noticed in areas of greater human concentration.

In the U.S., it has been estimated that there are approximately 500 million dwelling spaces that could potentially harbor bedbugs. These include approximately 10 million hotel/motel beds, 40 million dorm rooms and apartments, and 350 million other residential rooms. Other spaces where infestations might occur include rental rooms in vacation properties, ships, ferries, buses, and passenger train cars.

Peak bedbug biting activity is usually just before dawn. They can feed without waking their unwitting hosts. Meals are procured in as little as three minutes, after which the bedbugs are engorged and detach from their host, crawling into a nearby hiding place to digest their meal. Hosts (i.e., victims of bedbug bites) typically do not feel the bites because bedbugs inject a numbing agent into the body, along with an anticoagulant to keep blood flowing as they extract it. The first sign of bedbug bites may be itchy, red bumps on the skin, usually on the more readily accessible upper torso arms or shoulders. Bedbugs tend to leave straight rows of bites. Bedbug bites do not usually require treatment, although secondary infections can occur. Some people do have allergic reactions to bedbug bites, requiring medical attention.

Hosts passively lure bedbugs and other blood-consuming pests in multiple ways, but research has shown that the most effective attractants are heat and carbon dioxide (CO2). Some conventional bedbug traps attempt to emulate host-like heat and CO2 generation; they may also include pheromones, kairomones, and various other chemicals. Unfortunately, traps like these can have drawbacks. First, generating or releasing CO2 elevates the toxicity inside a living space. Second, because humans can generate upwards of 40 liters of CO2 each hour, bait chambers can be very bulky and rely on unstable or offensive chemical reactions to emulate human-level signatures. Third, refreshing the bait(s) can be expensive due the cost of the chemicals and labor. Finally, chemicals can be offensive and potentially toxic to humans and pets.

Quality hoteliers strive to provide guests with positive experiences. Steps are regularly taken to ensure that living spaces are hygienic, neat, affordable, and inoffensive. Hoteliers are very concerned about guest perceptions, in part because consumers rely heavily on reviews, which social media have made more voluminous and available. Hoteliers are also concerned about liability. And, of course, hoteliers are concerned about costs, whether from lost revenues or pest search-and-eradicate steps. Notably, some eradication steps require the destruction and removal of expensive furniture, fixtures and equipment. Further, false reports of bedbugs may cause expensive eradication steps to be taken unnecessarily.

Many consumers associate bedbugs and other pests with a lack of cleanliness. In truth, spaces may be “clean” per strict hygienic standards yet still host bedbugs, because bedbugs can be ushered into spaces by even the cleanest of hosts. While conventional “cleanliness” may not prevent bedbugs, an argument could be made that the presence of any pests constitutes a lack of cleanliness. This argument becomes more compelling when consumers realize that bedbugs discharge blood-based waste, lay up to five eggs per-day/per-female, deposit exoskeletons when they molt, and leave carcasses when they die.

Some consumers may also fear that bedbugs and other pests could facilitate communicable diseases, despite CDC claims to the contrary. After all, these pests extract, digest and eliminate trace elements of blood. In fact, a tell-tale sign that bedbugs reside in a space can be found in the bloodstains they leave, especially along the seams of mattresses. Bedbugs also leave dark spots of blood-based waste where they might crawl into hiding places on furniture, walls, and floors. Given the gravity of certain blood-borne diseases, even if the blood is digested and dried, it is easy to understand this fear.

Hoteliers understand and respect these concerns and the costly ramifications of a bad guest experience. Litigation is expensive. Medical bills are expensive. Lost loyalty is expensive. A tarnished reputation is expensive. And bedbug eradication is expensive. To the latter point, infestations can cost hoteliers hundreds and thousands of dollars per occurrence, with multiple occurrences possible annually.

To minimize the impact of litigation, hoteliers may wish to know not only whether pests of any kind are present but also which pests are present. Should any claims be made by guests, hoteliers will want to have verifiable information about which insects, if any, could have bothered the guests. One cannot necessarily assume bites are from bedbugs, or that the bites were even suffered while the guests were in the hotel. Bites can be hard to identify, even for doctors. It is best to collect and identify pests to identify the possible source of the bites.

Bedbug infestations can occur in a matter of weeks. While insecticides are available, they cannot be applied to areas that come in direct contact with skin, due to their toxicity. Also, modern bedbug populations are highly resistant to the insecticides used for their control. Freezing and very high temperatures can kill bedbugs without toxicity, but are infeasible as a preventative measure for living spaces. Similarly, Sterifab® kills bedbugs on contact, but does not leave residues and therefore cannot be used for preventative treatment.

### SUMMARY

Embodiments of the present invention provide discrete and safe insect monitoring systems that can attract, capture, detect, and identify insects and communicate its findings quickly. Because of their low cost and unobtrusiveness, the insect monitoring systems described herein are particularly useful for the hospitality industry, and broadly useful for transportation, residential, and other market segments.

An example of the insect trap and monitoring systems described herein includes an interior chamber portion, comprising side walls and a floor, each side wall having a bottom abutting the floor and a top away from the floor. Each side wall further has an interior bottom region adjacent to the floor and an interior top region adjacent to the interior bottom region and apart from the floor. The interior bottom region of each wall has a surface finish substantially smoother than a surface finish of the interior top region of the wall—in particular, while a target type of insect (such as a bedbug) can traverse the interior top region of each wall when the wall is in a vertical orientation, due to the relatively rough surface finish of this interior top region, an insect attempting to traverse the interior bottom region of the wall will slip and fall onto the floor and be unable to climb back up the wall, due to the smoother finish of that interior bottom region.

The example insect trap further comprises one or more pieces forming a ceiling to the interior chamber portion; in some embodiments all or part of this ceiling is transparent. The interior chamber portion of the trap and the one or more pieces that form the ceiling are configured so that one or more openings in or near the top of one or more of the side walls allow ingress of an insect of one or more target types to the interior of the interior chamber portion, onto the interior top region of one or more of the side walls. As suggested above, the one or more target types of insects may include bed bugs.

In some embodiments, the example insect trap described above includes a multi-pixel optical sensor disposed outside the interior chamber portion and arranged so that a field of view of the multi-pixel optical sensor encompasses at least a portion of the floor within the interior chamber portion. In these embodiments, at least part of the ceiling to the interior chamber portion is transparent, so that the image sensor can see into the interior chamber. These embodiments may further comprise a processing circuit configured to receive image data from the multi-pixel optical sensor, to analyze the image data to detect the intrusion of an insect or other object into the field of view of the multi-pixel optical sensor by comparing most recently received image data to previously received image data, and to generate an indication in response to detecting the intrusion of the insect or other object into the field of view of the multi-pixel optical sensor.

Other examples and variations of the insect traps summarized above are described in detail, with some of these examples being illustrated in the attached figures, which are described below.

### BRIEF DESCRIPTION OF THE FIGURES

FIG. 1 illustrates an inner trap portion.

FIG. 2 shows a lid for the inner trap portion of FIG. 1.

FIG. 3 illustrates an outer trap portion.

FIG. 4 shows a front housing.

FIG. 5 illustrates a rear housing.

FIG. 6 illustrates an imaging and electronics assembly.

FIG. 7 illustrates a button.

FIGS. 8A and 8B are process flow diagrams illustrating an example image processing algorithm.

FIG. 9 is a schematic diagram illustrating electrical components of an example insect monitoring system.

FIG. 10 is an exploded view of an example insect trap and monitoring system.

FIG. 11 is a view of an assembled insect trap and monitoring system.

### DETAILED DESCRIPTION

The innovative traps described herein are designed to address a priority bedbug problem for hoteliers. However, as discussed above, hotel rooms in the U.S. are a mere fraction of the total spaces that could benefit from this invention. Moreover, the traps and techniques described herein are not limited in application to bedbug detection, but may be applied to other indoor insect pests as well.

Various embodiments of the insect monitoring system described herein include several or all of the features described below.

Safety—A crevice-like entry port to the interior of the trap is too small for human or pet access, but ideally sized for insects. The primary bait may be any of or a combination of heat, infrared (IR) light, and a crevice-like entry port, all of which are benign. Secondary bait, in some embodiments of the inventive monitoring systems disclosed herein, is CO₂, which is naturally exhaled from host(s) and which can be captured at a point near or below their heads. (CO₂ is heavier than air and, thus, sinks after being exhaled.) In some embodiments, as described in further detail below, chemical baits may be passively or controllably dispersed. Insects that enter an interior chamber of a monitoring system as described herein, which interior chamber acts as a “photo booth” in automated embodiments, are entrapped on its floor by adhesives, fabric snares, gravity, slick walls, an out-of-reach port, a closable door, chemical and/or mechanical arrestants, or some combination thereof, in various embodiments. The electronics employed in some of the traps detailed herein are low-voltage and thus inherently safe—in contrast, some conventional traps on the market are actually embedded in AC voltage power strips, which can cause high-voltage shock.

Non-Pest Object Rejection—Other features of some embodiments of the monitoring systems detailed below are intended to minimize the likelihood that non-pest objects may enter the photo booth. These include, for example: (1) the use of a minimal aperture—the crevice-like entry port is sized for very small insects, minimizing the opportunity for dust, lint, and other foreign objects to enter; and (2) outflow—heat from the trap's electronics, particularly components at or near the photo booth floor, will rise inside the photo booth and be channeled through the crevice-like port (like a chimney); combined with a filtered air intake located away from the crevice-like port, and near or below the heat-generating components, this will create a continuous outflow of warm, clean air that will push suspended airborne objects away from the port and, thus, prevent them from entering the photo booth to produce false positive detection and/or classification results.

Remote Notification—Some of the traps described herein discretely convey detection and classification results via wireless communications, e.g., over optical and/or radio-frequency communication links; the use of alarm-like audible signals or lights is generally avoided. The traps may be network topology-agnostic, because they may be programmed and fitted to interface with a plethora of industry-standard network configurations, protocols and reference models. Communication topologies and techniques may include, but are not limited to, direct-to-access-point, multi-hop, query-response, multi-cast, etc. The traps discretely communicate, in a timely manner, detection and/or classification results to parties with a need-to-know, without drawing unwanted attention, and without requiring unnecessary labor. If operators desire more than the high-level detection/classification messages, some embodiments of the traps may receive and fulfill requests for additional information including, for example, pre- and post-processed images of insects caught in the traps.

Autonomous On-Board Detection—Several of the presently disclosed traps include optical sensors configured to capture multi-pixel images of insects intruding into the interior space of the trap. The traps include circuitry that performs on-board processing to detect changes in captured images and image features indicative of insects. The number of pixels may range from four to greater than 1000, in various embodiments. A relatively small number of pixels keeps the required processing power for onboard processing to reasonable levels, allowing the use of inexpensive and power-efficient processing circuits. Visible, infrared, and/or other illumination of the interior chamber may be used, to enhance the captured optical images. Because the traps are designed to ensure that insects become trapped in the invention's “photo booth,” image capture and process intervals may occur at slow frame rates, to minimize energy consumption by the device. Systems may be configured to enter sleep and/or power-off modes to further conserve energy.

Structured Lighting—Some embodiments of the disclosed traps may combine optical sensing with one of or combinations of several structured lighting approaches. First, to enhance contrast, some embodiments may use backlighting, e.g., through a floor of the interior chamber, opposite an imaging sensor, to produce silhouette images. Some embodiments may use angled lighting, to create shadows and enhance dimensionality. Some of these and some other embodiments may use flood lighting, to illuminate insects in the “photo booth” and to allow their features to be distinguished. Combinations of these techniques may also be used. Infrared (IR) lighting may be used, in some embodiments—in addition to its ability to lure bedbugs, tuning the imaging system to IR light can make the imaging less vulnerable to changes in ambient light, which can enter the photo booth through the crevice-like port.

Onboard Image Pre-Processing—In various embodiments of the inventive insect monitoring system described herein, any combination of background subtraction, noise filtering, contrast enhancement, global or local thresholding, and morphological opening may be applied to images captured within the system. Background subtraction computes the foreground of the image for analysis. Background subtraction could be implemented as simply as subtracting some original image, but, more likely, the background to be subtracted will be a weighted average of a series of previous images. Noise filtering may include one or more of several techniques, such as temporal filtering or spatial filtering via a low-pass filter. Noise reduction may occur before or after background subtraction. Light compensation and contrast enhancement may be applied, including, for example, intensity normalization, dynamic range compression, and/or histogram equalization algorithms. Then, a morphological opening may be applied to the resulting image in order better define the individual insects, if there is more than one. A global threshold calculated from the image histogram or local thresholds based on values of nearby pixels may be applied to the resulting image.

Onboard Region Identification—In some embodiments, basic detection of an insect is based on background subtraction only. Contrast detection or a high-pass filter may also be used, where gradients are calculated to define boundaries between objects and the background. In some embodiments, blob detection may also be employed to identify groups of adjacent pixels that may be indicative of one or more pests. Blobs are connected components that can be found using various techniques such as region growing. The results of this detection are frequently called regions of interest (ROIs) or just regions. As bedbugs have the tendency to become translucent when unfed, some regions may contain “holes.” Some embodiments may use a hole-filling procedure or morphological closing to remove these holes.

Onboard Region Description—There are a number of ways to determine whether a region of interest contains an insect or some other benign object. Each region has a number of descriptors that define properties of the region as a whole. These descriptors include color or grayscale histograms for the region, the shape of the region, size of the region, aspect ratios of the region, centroid of the region and other regional moments. Some embodiments of the automated insect monitoring system calculate these descriptors for regions of interest and compare them to known descriptors for common pests. The area occupied by an intruder, defined as the number of pixels in a blob or inside a boundary (also known as “hull”) may be used to define insects. Similarly, the perimeter of a region of interest, defined as the number of pixels along the boundary, may be used to identify insects. Aspect ratios, defined as ratios of the blobs' length-to-width, major-to-minor axis variance, or major-to-minor eigenvalues, can also be used to characterize a region of interest and then to identify insects.

Negative Feedback—Embodiments of the insect monitoring system may receive feedback from remote or proximal operators, including the results of background subtraction. Examples of feedback include, but are not limited to (1) indicators of dead pixels, likely malfunctioning photo-sites, which can be subsequently ignored so as to not be confused with pests; (2) indicators of non-pest objects, likely inert objects (e.g., lint, dust, airborne particles, etc.) that enter the photo booth, which can be subsequently ignored so as to not be confused with pests.

Autonomous On-Board Classification—Once a region of interest has been determined to contain an insect, it may be useful to classify the type of insect, to correctly combat the infestation. In some embodiments, onboard processing is adapted to perform autonomous classification of detected intruders in order to differentiate among several types of insects and/or among distinct stages of an insect's lifecycle. This implementation may include comparison of one or more region descriptors described above to stored profiles for two or more types or stages of insects. Once again, classification may be performed without requiring outside intervention from humans, whether on-site or remote. Methods of comparison may include simple differencing techniques and principle component analysis (PCA). Other moment-based techniques, including raw, central, scale-invariant, rotation-invariant and translation-invariant may also be used. Template matching may be used, in some embodiments, where one or more convolution kernels may be applied to regions of the image to detect similar patterns. Templates can be shapes of features or of entire insects, which may be “AND'ed” with the image at different rotations and at different scales. In some embodiments, a clustering or nearest-neighbor algorithm may be employed for classification. The error metrics for any of these algorithms might include a diverse set of region descriptors.

Advantages of some embodiments of the insect monitoring systems described herein include that the systems are cost-effective. Automated embodiments of the monitoring systems provide unattended pest detection, unlike alternative technologies, and can do so at a similar cost.

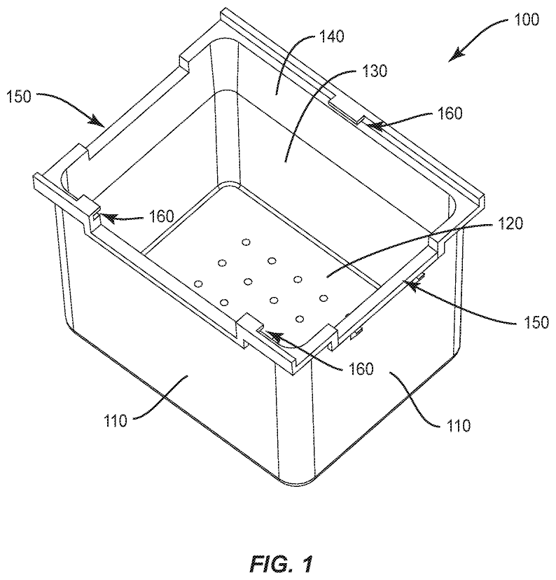

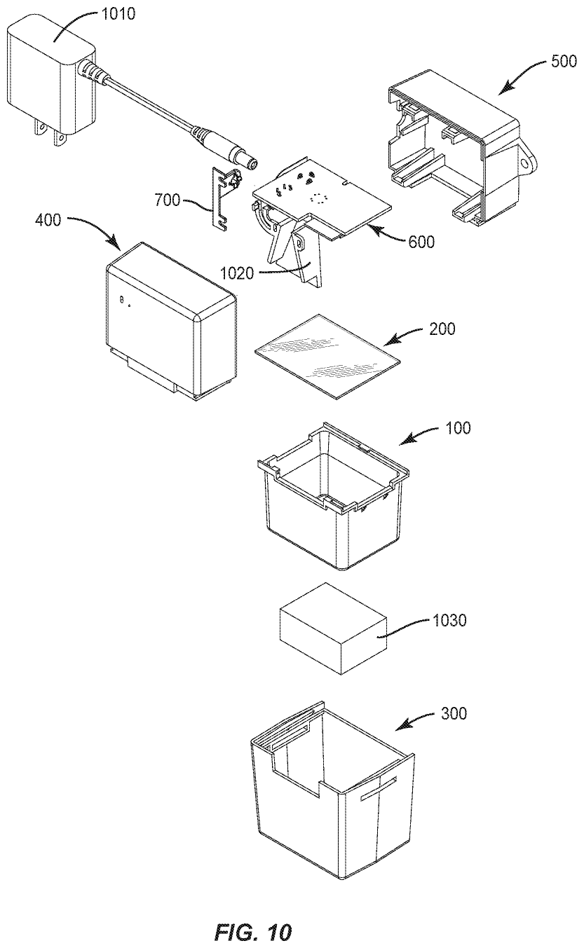

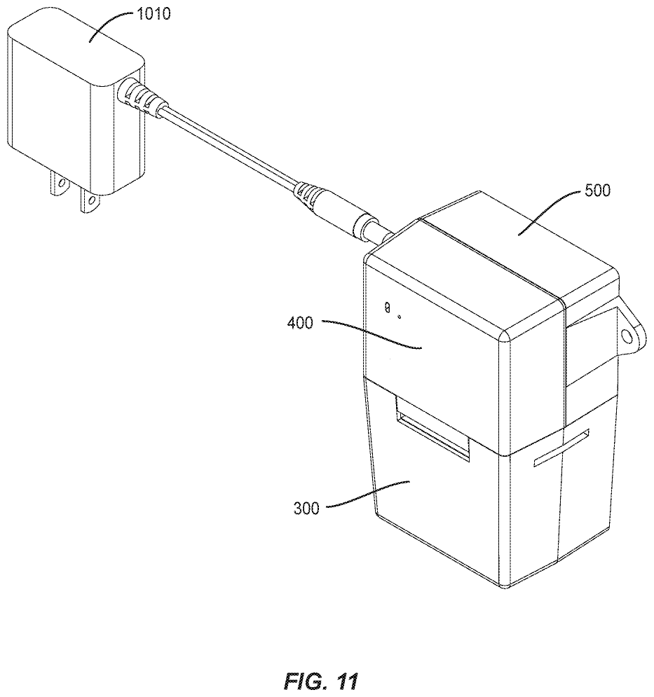

FIGS. 1-7 illustrate components of an example insect trap that incorporates many of the features described above, in addition to a novel design for the interior chamber of the trap that aids in trapping and preventing escape of target insects, such as bedbugs. FIG. 10 illustrates an exploded view of the example insect trap, while FIG. 11 illustrates the assembled insect trap. It should be understood that many of the details illustrated in these figures are provided for completeness but are not essential to every embodiment of the inventive techniques described herein. The illustrated insect trap includes six primary components: an inner trap portion 100, a trap lid 200, an outer trap portion 300, a front housing portion 400, a rear housing portion 500, and an electronics/imaging assembly 600. Other parts include a button 700 and power supply 1010. It will be appreciated that several of these portions may be omitted entirely while others may be combined, in various embodiments of the invention, and the details of the assembly and interconnections between the portions may vary, based on any number of design considerations. For example, the front housing portion 400 and rear housing portion 500 may be combined, in some embodiments, or omitted entirely in other embodiments. Not all insect traps need the electronics/imaging assembly 600. Likewise, while the separate inner trap portion 100 and outer trap portion 300 shown in the figures facilitate the easy use and replacement of bait, the outer trap portion 300 might be omitted in some embodiments. In short, while the details shown in the figures are illustrative and explanatory of various inventive concepts, the figures should not be considered as limiting the application of these inventive concepts.

FIG. 1 shows several views of an inner trap portion 100. Inner trap portion 100 forms an interior chamber portion of the trap, comprising side walls 110 and a floor 120, each side wall 110 having a bottom abutting the floor 120 and a top away from the floor 120. Each side wall 110 has an interior bottom region 130 adjacent to the floor 129 and an interior top region 140 adjacent to the interior bottom region 130 and apart from the floor 140. In the pictured embodiment, floor 120 is perforated; as discussed below, this allows a bait material to be placed under the inner trap portion 100 in such a way that the odor of the bait lures a target insect into the inner trap portion 100.

To facilitate the trapping of target insects, the interior bottom region 140 of each wall 110 has a surface finish that is substantially smoother than the surface finish of the interior top region 130 of the wall 110. More particularly, the surface finish of the interior top region 130 is selected to be coarse enough that a target type of insect (such as a bedbug) can traverse the interior top region 130 of any of the walls 110 when the wall is in a vertical orientation. At the same time, the surface finish of the interior bottom region 140 of each of the walls 110 is selected to be so smooth that an insect of the target type attempting to traverse the interior bottom region 140 of the wall 110 will slip and fall onto the floor 120 and be unable to climb back up the wall 110. Accordingly, the present document's description of one region having a surface finish that is substantially smoother than the surface finish of another region should be understood as referring to surface finishes that bridge the divide between surfaces that an insect of the target type is unable to successfully traverse, when those surfaces are in a vertical orientation, and surfaces that an insect of that same type can traverse, in a vertical orientation.

In some embodiments, the interior trap portion 100 is formed from plastic. In some of these embodiments, the surface finishes for one or both of the interior bottom region 140 and interior top region may be specified by or characterized by the surface finish categories defined by the Society of the Plastics Industry (SPI). These surface finishes and their associated characteristics are illustrated in Table 1, below. It has been determined that surface finishes of D-2 or D-3 allow a bedbug to successfully traverse a vertical region of that finish, while polished finishes of category A-1, A-2, or A-3 are slippery enough that a bedbug will slip and fall off a vertical wall of that finish. Thus, with respect to bedbugs, a surface finish of A-1, A-2 or A-3, as defined by the SPI, may be regarded as substantially smoother than a surface finish of D-2 or D-3. It is expected that straightforward experimentation for bedbugs or other types of insects might show that a surface finish of D-1 is sufficiently coarse enough for use on interior top region 130 and/or that medium-polish finishes B-1 and/or B-2 are sufficiently smooth enough for use on interior bottom region 140.

TABLE 1

| SPI Finish | Guide | Typical Applications |
|---|---|---|
| A-1 | Grade #3 Diamond | Lens/Mirror |
| A-2 | Grade #6 Diamond | High polish parts |
| A-3 | Grade #15 Diamond | High polish parts |
| B-1 | 600 grit paper | Medium polish parts |
| B-2 | 400 grit paper | Medium polish parts |
| B-3 | 320 grit paper | Medium-low polish parts |
| C-1 | 600 stone | Low polish parts |
| C-2 | 400 stone | Low polish parts |
| C-3 | 320 stone | Low polish parts |
| D-1 | Dry blast | Satin finish |
| D-2 | Dry blast #240 oxide | Dull finish |
| D-3 | Dry blast #24 oxide | Dull finish |

Another industry classification of surface finishes are defined by the MoldTech (MT) specifications. The categories of surface finishes according to the MoldTech specifications include the MT-11030 coarse finish, which is used for applications that require extra durability, high grip, and maximum scratch resistance. They also include the MT-11020 medium finish, which provides grip and durability but with lighter texture than the coarse finish, and the MT-11010 light finish, which provides a subtler roughness. These categories also include the MT-11000 matte finish, which provides a smooth, non-glare finish. Finally, these categories include a “gloss” finish, which may be comparable to the SPI A-2 or SPI A-3 high polish finishes. With respect to bedbugs, it has been determined that an MT-11030 surface finish is sufficiently rough/coarse for the top interior region 130, while any of the surface finishes characterized above as “high polish” is adequate for the bottom interior region 140. Again, straightforward experimentation can determine whether other surface finishes may be suitable for either region, for bedbugs or other types of insect.

It will be appreciated of course, that appropriate surface finishes for the top interior region 130 and bottom interior region 140 may be defined or characterized by other schemes or scales of roughness and/or polish. Surface finishes for other portions of the inner trap portion 100 may vary; these other surfaces need not be highly polished, in many embodiments.

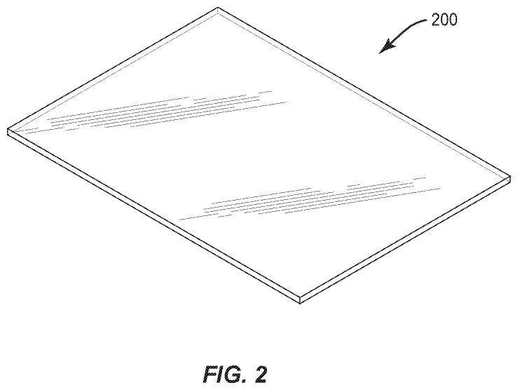

Insect traps according to various embodiments of the present invention include one or more pieces forming a ceiling to the interior chamber portion, e.g., as formed by interior trap portion 100. FIG. 2 illustrates a simple example, consisting of a simple lid 200. In the example trap shown in the figures, lid 200 is transparent, to allow visual inspection and/or optical imaging of the interior chamber when the lid 200 is in place.

Lid 200 may be affixed to interior trap portion 100 by sliding the lid 200 into the slots 160 shown in FIG. 1, until the lid 200 covers the top of interior trap portion 100. Notably, interior trap portion 100 is formed with notches 150, so that an opening is formed when the lid is installed and bridges the notches 150 at each of two ends of the interior trap portion; those openings, which are at the tops of the opposing side walls, allow ingress of an insect of one or more target types to the interior of the interior chamber portion, onto the interior top region 130 of the respective side walls 110. Other configurations of the interior trap portion 100 and lid 200, such that one or more openings are formed in or near the top of one or more of the side walls 110, are possible. In some embodiments, two or more pieces may form a ceiling to the interior chamber portion of the trap, rather than the single lid 200 shown in the illustrated example.

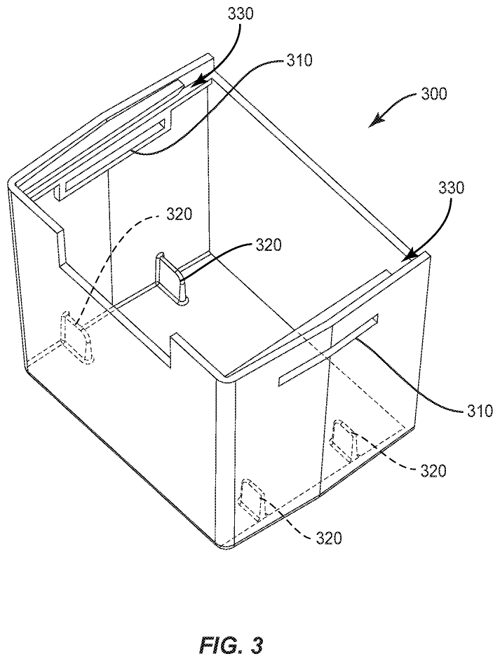

FIG. 3 illustrates an outer trap portion 300, which is configured to receive the inner trap portion 100. The inner trap portion 100, with lid 200 installed, may be dropped into the large opening at the top of outer trap portion 300; outer trap 300 is sized with adequate clearance to receive the entirety of inner trap portion 100. When inner trap portion 100 is positioned entirely within outer trap portion 300, the openings formed by the notches 150 in inner trap portion 100 line up with the openings 310 in the end side walls 300.

Spacers 320 inside and at the bottom of the outer trap portion 300 keep inner trap portion 100 spaced away from the floor of outer trap portion 300, so as to form a reservoir region between the floor of inner portion 100 and the floor of outer trap portion 300. This allows a bait material to be securely disposed in the reservoir region—as shown in the exploded assembly view of FIG. 10, bait material 1030 can simply be dropped into the outer trap portion 300 before the inner trap portion 100 is installed. The perforations in the floor of inner trap portion 100 allow the scent of the bait material to flow into the interior chamber formed by the inner trap portion, and out the openings of the outer trap portion 300, luring target insects into the interior chamber of the trap.

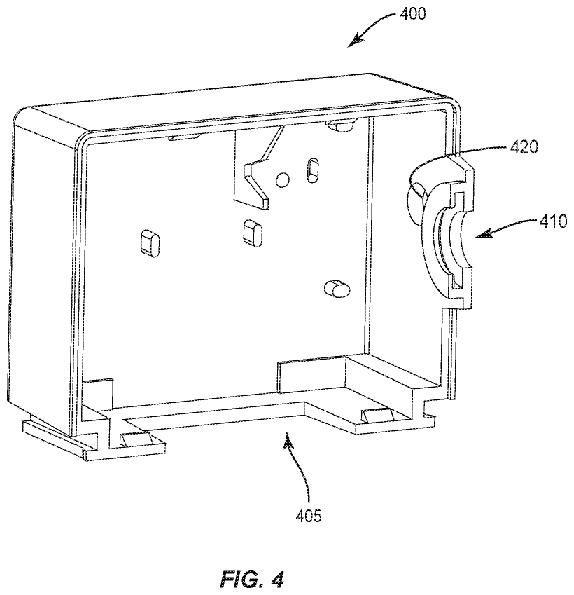

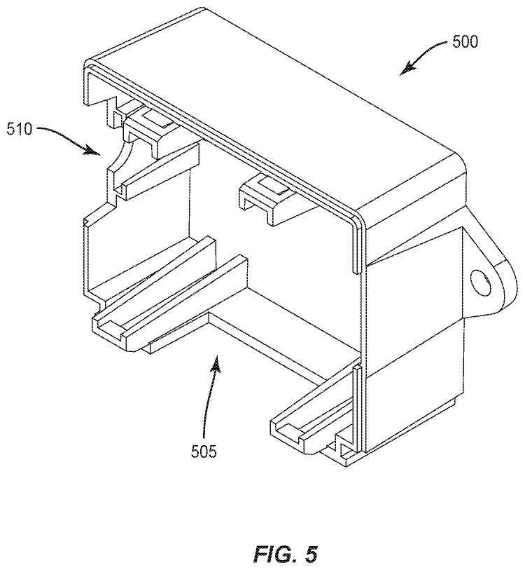

As suggested above, several embodiments of insect traps according to the presently disclosed concepts may include imaging apparatus and processing circuitry, to automatically detect intrusion of insects into the interior of the trap and, in some cases, to classify those insects. Provision of the imaging apparatus and associated electronics is facilitated in the example trap shown in the figures by the front housing 400 and rear housing 500 shown in FIG. 4 and FIG. 5, respectively. Front housing 400 and rear housing 500 fit together and slidably engage with the grooves 330 in outer trap portion 300, so that the housing formed by front housing 400 and rear housing 500 are positioned atop the outer trap portion 300. When front housing 400 and rear housing 500 are positioned together, an opening is formed by large notches 405 and 505; when the front housing 400 and rear housing are installed atop the outer trap portion 300, with the inner trap portion 200 installed inside the outer trap portion 300, this opening is positioned above the transparent lid 200. An imaging apparatus and associated electronics may be arranged inside the housing so formed, above the transparent lid 200, with the imaging apparatus positioned so as to have a field of view that encompasses at least a portion of the floor within the interior chamber portion formed by inner trap portion 100.

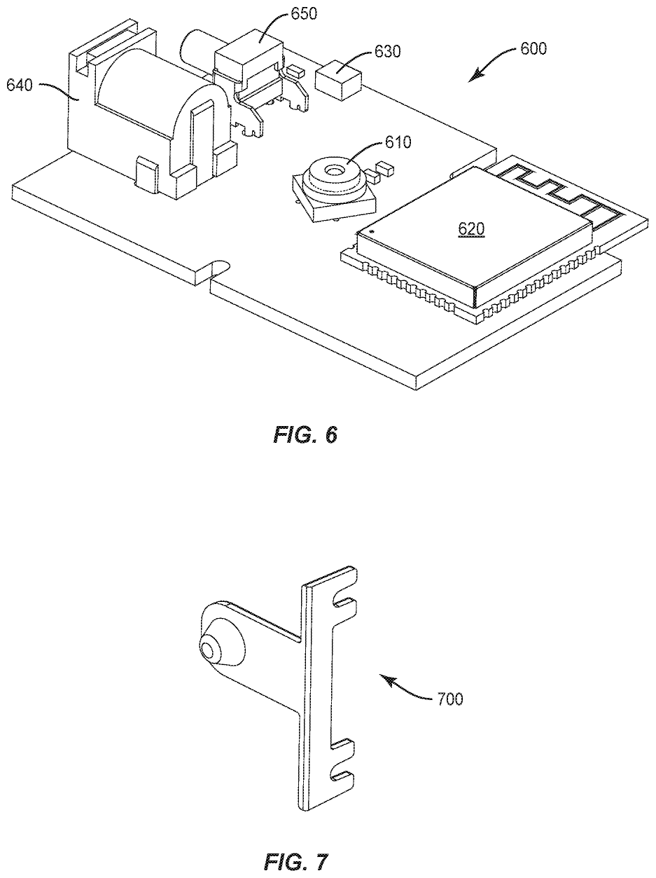

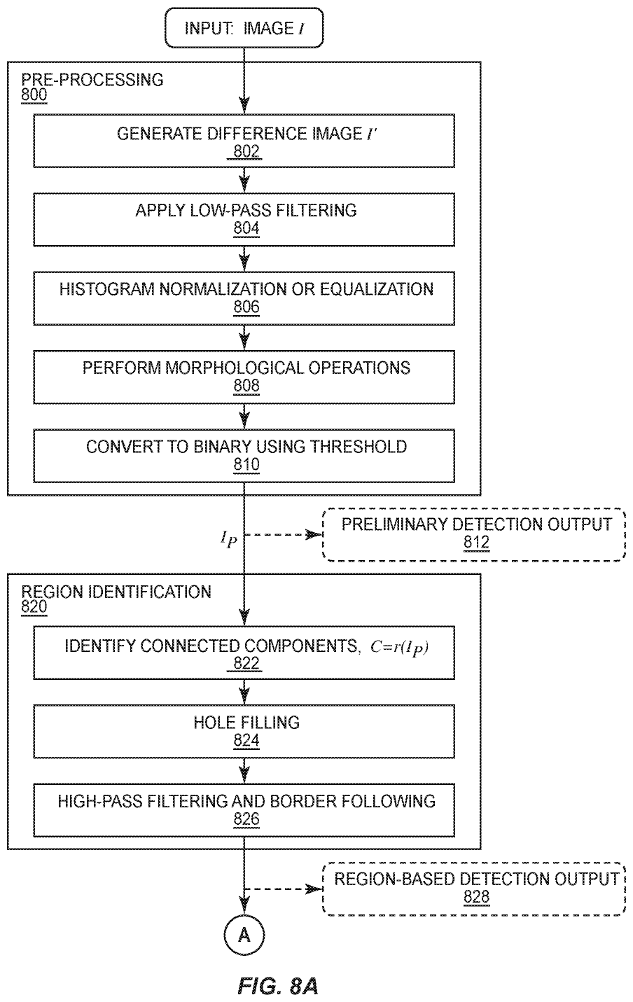

Notches 410 and 510 in front housing 400 and rear housing 500, respectively, fit together to form an opening for a button, to allow an installer of the trap assembly to turn off or on electronics housed within. An example of a button 700 is shown in FIG. 7. An opening 420 in front housing provides an entry point for a power supply plug, which may engage a power supply jack 640 connected to electronics housed within the front housing 400 and rear housing 500. Power supply jack 640 is shown in the illustration of imaging and electronics assembly 600 of FIG. 6, while an example power supply 1010 is shown in the exploded assembly view of FIG. 10 and in the assembled view of the insect trap in FIG. 11.

FIG. 6 illustrates an example imaging and electronics assembly 600, which includes an optical sensor 610 and electronics circuit 620. When the imaging and electronics assembly 600 is arranged within the front housing 400 and rear housing 500, the optical sensor 610 is positioned so as to have a field of view that encompasses at least a portion of the floor 140 of the interior chamber portion formed by inner trap portion 100. The illustrated imaging and electronics assembly 600 further includes a jack 640, for receiving a power supply connection, and a switch 650; when the insect trap is assembled, as shown in FIGS. 10 and 11, button 700 may selectively engage switch 650, under user control, to activate the electronics and imaging components.

Optical sensor 610 may be a multi-pixel optical sensor and may be coupled with a lens assembly. Optical sensor 610 is connected to electronics circuit 620, which in turn may comprise a processor, memory, and a communications circuit, in some embodiments. In some embodiments, imaging and electronics assembly 600 may further comprise a light source 630, arranged so that it illuminates at least a portion of the surface of floor 140. The light source 630 may be a single point source, such as a light-emitting diode (LED). In some embodiments, the light source may be positioned so that it illuminates the surface of the floor 140 from an angle (relative to the floor surface's perpendicular), to generate shadows on the surface of the floor from an insect or other object on the floor's surface. These shadows can be exploited by the image processing to enhance insect detection and/or identification. Of course, while only a single point light source is illustrated, two or more point sources, e.g., LEDs, may be used in some embodiments, e.g., to provide more intense or more uniform illumination.

In some embodiments, light from light source 630 is coupled to the interior chamber of inner trap portion 300 via a light pipe 1020, an example of which is shown in the exploded assembly view in FIG. 10.

In other embodiments, the illumination of the floor 140 is not provided by shining light through the interior chamber but is instead provided from behind a transparent or translucent portion of the floor 140.

The light source may emit visible or invisible light (e.g., infrared), in various embodiments. Infrared light may be particularly advantageous in some embodiments, for several reasons. For example, if the input or output of the optical sensor 610 is tuned (e.g., through optical filtering, digital filtering, or other means) so that the resulting image data reflects a sensitivity to infrared light but less sensitivity to visible light, then the system will be less sensitive to variations in ambient light that may leak into the interior chamber from outside the trap assembly. Further, infrared light is expected to be a lure for bedbugs—as a result, infrared illumination leaking from inside the interior chamber to the outside of the device may attract bedbugs to the interior chamber.

As noted above, the optical sensor 610 may be a multi-pixel sensor, arranged within the housing so that the sensor's field of view covers a substantial portion of the surface of the floor 140. As a result of this configuration, each of the multiple pixels of the optical sensor 610 corresponds to, i.e., can be mapped to, a segment of the floor surface. In the illustrated embodiments, the optical sensor 610 is arranged so that when the assembly 600 is installed in the housing formed by front housing 400 and rear housing 500, the optical sensor 610 is directly opposite the surface of the floor 140 so as to have a head-on view of the floor section's surface. It will be appreciated, however, that the optical sensor 610 may be arranged at any of several other points around the housing, e.g., so that it has an angled view of the surface of the floor 140, so long as the sensor's field of view encompasses a substantial part of the floor section's surface.

The multi-pixel optical sensor 610 used to obtain an image of the floor surface and any insect situated on it may be a relatively low-resolution sensor, in some embodiments, with a number of pixels ranging from at least four to as many as about 100,000. Some embodiments may use a sensor with 340×240 pixels, for example. In an example embodiment, the imaged surface, corresponding at least the majority of the surface of floor 140, is about 40 millimeters by 50 millimeters. A smaller number of pixels may be suitable for embodiments in which only detection of an intruding insect is needed, or for embodiments where the multi-pixel sensor is moved (i.e., translated and/or rotated) while capturing image data, so as to “scan” the imaged surface. In embodiments where classification of the insect is desired, more pixels and a higher resolution may be needed, so that the smallest insect that is anticipated to be imaged occupies enough pixels in a captured image for the appropriate processing to be carried out. Requirements for a lens will depend on the placement of the multi-pixel optical sensor, relative to the internal chamber.

The electronics shown in the embodiments illustrated above include a processing circuit (in electronics circuit 620) configured to receive optical data from the multi-pixel optical sensor, to analyze the optical data to detect the intrusion of an insect or other object into the interior chamber of the trap by comparing recently received optical data to previously received optical data. A difference between the recent data and the previous data, if significant enough, indicates that something has moved into the image field. In some embodiments, the processing circuit then generates an indication in response to detecting the intrusion of the insect or other object into the interior chamber. In some simple embodiments, this indication is simply an indication that an intrusion has been detected. In other embodiments, the difference-based detection described above triggers further processing to refine the detection decision, e.g., to reduce false alarms, and/or to attempt a classification of the intruding object. The processing circuit includes, in an exemplary embodiment, a microprocessor and associated memory as well as a communications circuit. The memory stores program instructions, e.g., in flash memory or other nonvolatile memory, for execution by the microprocessor to carry out one or more of the several methods described herein. The memory also includes working memory, such as random-access memory (RAM) or other volatile or non-volatile memory, for use by the microprocessor in carrying out these methods and/or for communicating through the communications circuit.

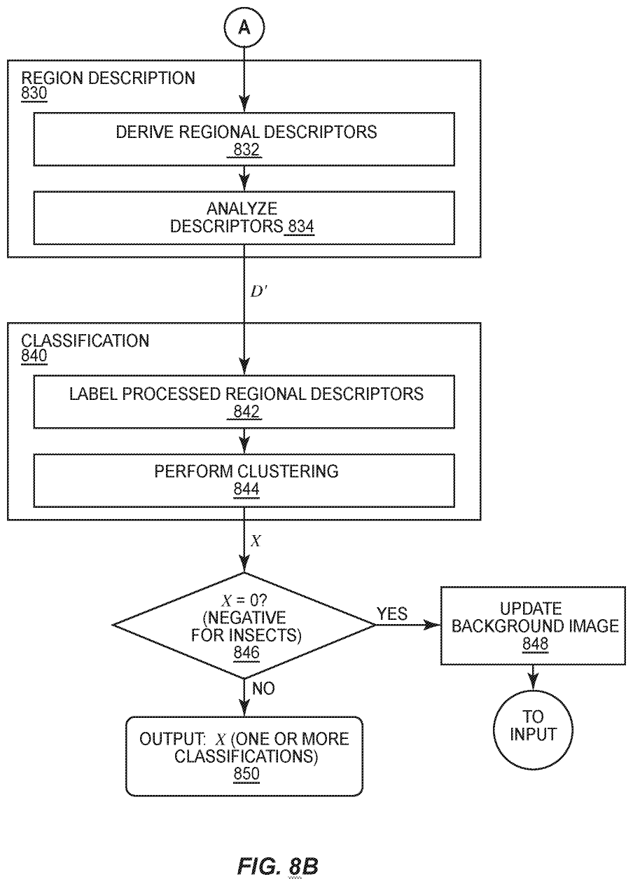

FIGS. 8A and 8B illustrate a process flow diagram illustrating a detection and classification algorithm that might be used in some embodiments. It will be appreciated that some embodiments might use only the detection portion of the illustrated algorithm, while others may use variations of the exemplary image processing and insect classification techniques illustrated in FIGS. 8A and 8B.

The input to the process flow shown in FIG. 8A is a multi-pixel image I obtained from the optical sensor 610. The image data, I, is first provided to a pre-processing stage 800. This stage includes a background subtraction operation, 802, which generates a difference image I′ as a function of image I and a background image B. As will be discussed in further detail below, the background image B is derived from at least one previous image, e.g., from a weighted average of previous images from the optical sensor. Subtracting the background image increases the contrast of the processed image and removes artifacts in the image I that may be caused by dust, burnt-out pixels, etc.

As shown at blocks 804, 806, and 808, the difference image I′ is subjected to one or more of a low-pass filtering function g(I′), histogram normalization or equalization function n(I′), and/or one or more morphological operations m(I′). The most basic morphological operations are erosion and dilation. Erosion contracts or deflates a region of pixels by decreasing the value of the boundary pixels. Dilation expands or inflates a region of pixels by increasing the value of the boundary pixels. Morphological opening is the dilation of an eroded image, and morphological closing is the erosion of a dilated image. Note that any one or more of these operations might be omitted, in various embodiments. Finally, as shown at block 810, the processed image data is made binary by comparing pixel values to a global or local threshold. This process may be global, e.g., comparing every pixel to the same value, or local, e.g., comparing each pixel to a value that is calculated using the values of its neighboring pixels.

In any case, the output of the pre-processing stage 800 is a preliminary detection output, as shown at block 812. This output is positive, indicating at least the possibility of a detected insect, if the sum of the processed pixel intensities in the entire image area or in a localized region is greater than an empirically determined threshold, and negative otherwise. In some embodiments, the image processing may stop here, and the preliminary detection output is reported. In others, this preliminary detection output instead serves as a trigger for further processing.

In the process flow illustrated in FIGS. 8A and 8B, however, the preliminary detection output triggers further processing of the image data, including a region identification sub-process 820. This sub-process includes, as shown at block 822, the step of identifying a set of connected components in the processed pixel data, i.e., identifying connected components C=r(I_{P}), where C is the set of connected components, I_{P} is the processed pixel data, and r(*) is the region-growing function. Connected components may be found using a region-growing or contour retrieval function. Region growing involves searching the neighborhood of a seed pixel for other pixels of the same value until, continuing until no more pixels of the same value are found. Retrieving image contours generally involves high-pass filtering followed by border following, as shown at block 826. Prior to this step, a hole-filling algorithm may be employed to fill in the translucent stomachs of the unfed insects, as shown at block 824. Hole filling could be achieved through morphological closing or a similar technique.

In some embodiments, each of the identified connected components (as processed by the high-pass filter and hole-filling functions, as applicable) is evaluated to determine whether there is a connected component that exceeds a particular size. As shown at block 828, these embodiments may provide a region-based detection output, based on this evaluation, that is positive for intrusion detection in the event that the size (i.e., area) of any connected component is greater than an empirically derived threshold value, and negative otherwise. This region-based detection output may be reported (as discussed in further detail below) in some embodiments, or may simply serve as a trigger for a classification sub-process, in others. In some embodiments, for example, the threshold value may represent a minimum occupied area for an adult target insect, such that a determination that the size of any connected component exceeds this threshold value indicates that an adult insect is likely to be present.

Continuing from the process flow shown in FIG. 8A, FIG. 8B illustrates a region description sub-process 830. As shown at block 832, this sub-process derives one or more regional descriptors corresponding to each of one or more regions in a connected component C′, e.g., according to a function D=q(C′), where D is the set of regional descriptors, C′ are the processed connected components derived from the image data according to the steps shown in region-identification sub-process 820, and q(*) is a function that quantifies the descriptors D. Region description sub-process 830 may further comprise an analysis step that analyzes the descriptors, using techniques such as principal components analysis (PCA), providing an output D′=a(D), where a(*) is a function that analyzes the descriptors D. This is shown at block 834.

The output from region-description sub-process 830 is provided to a classification sub-process 840. Here, as shown at block 842, the processed regional descriptors D′ are labelled based on their likeness to each of a set of possible classifications. In some embodiments, clustering may be employed, as shown at block 844, to compare the descriptors D′ to the descriptors for common insect variants. The output of the classification sub-process 840 can be formulated as X=s(D′), where X is a set of classifications (which may be binary) for each region and s(*) is a classification function. X may consist of a binary determination of whether or not the intruder belongs to a certain class of insect, e.g. bedbugs, or may differentiate among a number of insect classes, e.g. bedbugs, ants, roaches, etc., in some embodiments. In some embodiments, X may be a vector that indicates two or more characteristics of the detected intruder, such as species, sex, age, size, etc.

It will be appreciated that in embodiments of the example analysis approach detailed above, as well as in variants of this approach, the classification sub-process 840 shown in FIG. 8B includes an analysis of the processed image data to determine whether the intruding insect or object meets one or more predetermined characteristics with respect to size, shape, or both. For example, the one or more predetermined characteristics may comprise a minimum occupied area, such that the analysis of the image data includes determining whether the intruding insect or other object occupies an area exceeding the minimum occupied area. This may indicate, for example, that an introducing insect is an adult, or has recently fed, in various embodiments. As another example, the one or more predetermined characteristics may include a shape, such that the analysis of the image data determining whether the intruding insect or other object has a feature matching the shape. The matching of one or more particular shapes may indicate a sex or species of insect, for example.

The results of the classification sub-process can be used to determine whether an intruder is present at all and/or to identify a type of intruder. The results, if negative, can also be used to update the background image, to improve subsequent processing. As shown at blocks 846 and 848, a classification result of X==0, i.e., a classification result that is negative for insects of any type, results in an updating of the background image used in subsequent processing, as shown at block 848. This may be done according to a function N=k(I′, B), where k(*) is a temporal filter to incorporate the new image into the background image. After the background image is updated, the image processing shown in FIGS. 8A and 8B may be repeated, using a new image I.

If the classification result indicates that an insect was detected, on the other hand, the output indicates the classification or set of classifications that apply to the analyzed image, as shown at block 850. This may specify a particular type of insect or a life-stage for a particular type of insect, in some embodiments. Note that in some embodiments and in some circumstances, this classification result may indicate that while an insect was detected, no classification was possible.

In some embodiments, further action in response to the detection of an intrusion, such as a notification or alarm, may be withheld unless specific classifications and/or multiple events are detected. For example, the trap may be configured to send a notification or otherwise trigger an alert or alarm in the event that a single adult female bedbug is detected, while otherwise withholding an alert or alarm or other action until two adult males (or other classifications, or unclassifiable intrusions) are detected.

Still other variations of the image analysis and alert reporting are possible. For example, bedbugs that have recently fed may be difficult to classify as male or female, due to abdominal distension caused by the feeding. In some embodiments, then, the processing circuit may be configured to delay all or part of the analysis to classify the intruding insect or object until a predetermined time period after the intrusion is first detected.

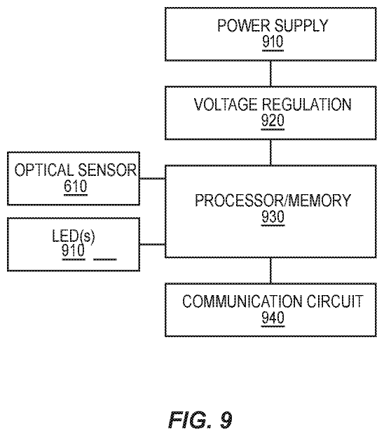

FIG. 9 is a schematic diagram illustrating the electronics included in some embodiments of the insect monitoring systems described herein. These electronics consist of three major subsections: power, processing, and communications. The power supply circuit 910 has a modular design, in some embodiments, allowing the design to be changed to best fit a specific market. In some embodiments, the power supply circuit 910 interfaces to AC power provided from a wall outlet, while in others it is powered by one or more batteries, e.g., a pair of conventional AA batteries. It will be appreciated that the details of the power circuit 910 will vary, depending on the input and the specific requirements, but it will be further appreciated that various circuit designs for a wide range of inputs and performance requirements are well known.

The illustrated example circuit further shows a voltage regulation circuit 920, which operates to bring the voltage down to an operating level for powering the optical sensor 610 and electronics circuit 620. An appropriate output voltage for the voltage regulation circuit 920 may be 1.8 volts, for example, although other voltages are possible. Again, designs and components for providing the necessary performance of voltage regulation circuit 920 are well known.

Processor/memory circuit 930 can either be standalone or contained within an applications-specific integrated circuit (ASIC) that also comprises the communications circuit 940. The processor/memory circuit 930 comprises one or more microprocessors, microcontrollers, digital signal processors, or the like, coupled to memory that stores program instructions for carrying out control of the insect monitoring system and for carrying out any of the image processing techniques described above. A communications circuit 940 is configured to support at least one wireless communications technology, preferably (although not necessarily) according to an industry standard protocol, such as Bluetooth®, Wi-Fi, etc.

The processor/memory circuit 930 reads pixels from the multi-pixel optical sensor 230 to generate an image, and then applies one or more of the above-described algorithms, or variants thereof, to detect insect intruders and/or classify the intruding insects. Using general purpose I/O pins, the processor/memory circuit 930 can toggle the LED(s) 910 as necessary, e.g., to provide constant illumination or flashing illumination, etc. Upon obtaining a detection and/or classification result, the processor/memory circuit 930 sends a message to a remote device, the device carrying an indication that an insect has been detected. Any or all of the detection and/or classification results may be forwarded as part of this message, or in response to a query received from the remote device. In some embodiments, no image data is forwarded to the remote device. In other embodiments, image data is forwarded along with the detection/classification indication. In still others, image data associated with a detection/classification event may be stored in memory, and subsequently forwarded to a remote device in response to a specific inquiry.

In some embodiments, the communications circuit 940 is also designed for modularity, so that the specifics of the supported communications link can be changed to best suit a specific market. Circuits supporting Bluetooth Smart®, ANT+, and Wi-Fi are currently available and may be suitable for various applications of the insect monitoring system. Each has its own drawbacks and benefits; power consumption, the availability of email alerts, phone connectivity, and network privacy are all considerations.

While the use of chemicals may be unnecessary or undesirable in applications, some variants of the insect monitoring systems described above contain a means to dispense chemical compounds, such as attractants, repellants and arrestants. These compounds may be synthetic or natural pheromones, kairomones, essential oils, etc. They may also be in liquid, solid, and vapor states. Additionally, they may be suspended in a gel. They may also be contained in reservoirs, vessels, or wrappers with one or more apertures, including porous membranes, to limit the outflow. A reservoir formed between the inner trap portion 100 and outer trap portion 300, as discussed above, is designed to receive and store these compounds, which may be provided in removable and replaceable packaging. In some embodiments, an attractant disposed in one of the monitoring systems described herein may include insect harborage material, such as shredded paper, fabric, or other material that previously provided a nesting area for insects. Preferably, such insect harborage material is treated, prior to use, to make it non-viable, in that it no longer includes eggs or other living material. Unlike other traps, which require specific attractant, arrestant or repellant compounds, the disclosed trap and monitoring system can be compound-agnostic.

Several embodiments of inventive insect traps and monitoring systems have been described above. The described systems provide a safe, effective, and inexpensive solution for automatically monitoring dwelling spaces for the presence of insects, and provide rapid notification of any detected infestations. It is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

What is claimed is:

1. An insect trapping system, the insect trapping system comprising:
an interior chamber portion, comprising side walls and a floor, each side wall having a bottom abutting the floor and a top away from the floor, each side wall further having an interior bottom region adjacent to the floor and an interior top region adjacent to the interior bottom region and apart from the floor, wherein the interior bottom region of each wall has a surface finish substantially smoother than a surface finish of the interior top region of the wall; and
one or more pieces forming a ceiling to the interior chamber portion;
wherein the interior chamber portion and the one or more pieces are configured so that one or more openings in or near the top of one or more of the side walls allow ingress of an insect of one or more target types to the interior of the interior chamber portion, onto the interior top region of one or more of the side walls.

2. The insect trapping system of claim 1, wherein the one or more target types included bed bugs.

3. The insect trapping system of claim 1, wherein the interior chamber portion is formed of plastic and wherein the interior top region of each side wall has a surface finish no less rough than an MT11030 surface finish, as defined by MoldTech specifications, and the interior bottom region of each side wall has a high-polish or smoother surface finish.

4. The insect trapping system of claim 3, wherein the interior bottom region has a surface finish of A-2 or A-3, as defined by the Society of the Plastics Industry (SPI).

5. The insect trapping system of claim 1, wherein the interior chamber portion is formed of plastic and wherein the interior top region of each side wall has a surface finish of D-1, D-2, or D-3, as defined by the Society of the Plastics Industry (SPI), and the interior bottom region of each side wall has a surface finish of A-1, A-2, or A-3, as defined by the SPI.

6. The insect trapping system of claim 1, wherein the one or more pieces forming a ceiling to the interior chamber portion comprise a transparent lid affixed to the interior chamber portion so as to cover a top opening of the interior chamber portion.

7. The insect trapping system of claim 6, wherein the transparent lid and interior chamber portion are formed so that the transparent lid is held in place by grooves formed near the tops of an opposing pair of the side walls.

8. The insect trapping system of claim 6, wherein each of one or more of the openings is formed by a notch at the top of a side wall, a top side of the notch being bridged by the transparent lid.

9. The insect trapping system of claim 6, further comprising:
a multi-pixel optical sensor disposed outside the interior chamber portion and arranged so that a field of view of the multi-pixel optical sensor encompasses at least a portion of the floor within the interior chamber portion; and
a processing circuit configured to receive image data from the multi-pixel optical sensor, to analyze the image data to detect the intrusion of an insect or other object into the field of view of the multi-pixel optical sensor by comparing most recently received image data to previously received image data, and to generate an indication in response to detecting the intrusion of the insect or other object into the field of view of the multi-pixel optical sensor.

10. The insect trapping system of claim 9, wherein the processing circuit is further configured to analyze the image data to determine whether the intruding insect or object meets one or more predetermined characteristics with respect to size, shape, or both, in response to detecting the intrusion of an insect or other object into the field of view of the multi-pixel optical sensor, and to generate the indication further in response to determining that the intruding insect or other object meets the one or more predetermined characteristics.

11. The insect trapping system of claim 1, further comprising an exterior chamber portion configured to receive and hold the interior chamber portion.

12. The insect trapping system of claim 11, wherein the interior chamber portion comprises one or more perforations passing through the floor of the interior chamber portion and into a reservoir region beneath the floor of the interior chamber portion and between the interior chamber portion and the exterior chamber portion, each of the one or more perforations being small enough to prevent ingress or ingress of the target insect.

13. The insect trapping system of claim 12, further comprising a bait material disposed in the reservoir region.

14. The automated insect monitoring system of claim 13, wherein the automated insect monitoring system further comprises a wireless communication circuit, and wherein the processing circuit is configured to send a message via the wireless communication circuit in response to the generated indication, the message indicating that an insect intrusion has been detected and/or indicating a classification of a detected insect.
